(19) United States
(12) Patent Application Publication
(10) Pub. No.: US 2003/0209167 A1
(43) Pub. Date: Nov. 13, 2003

(54) Dental retrograde-filling material containing cobalt and process

(76) Inventors: Feng-Huei Lin, Taipei (TW); Chun-Pin Lin, Taipei (TW); Wen-Hsi Wang, Taipei (TW)

Correspondence Address: KAO H. LU, 686 LAWSON AVE, HAVERTOWN, PA, 19083, US

(21) Appl. No.: 10/198,535

(22) Filed: Jul. 18, 2002

(30) Foreign Application Priority Data
May 7, 2002 (TW) 091109420

(51) Int. Cl. C09K 3/00

(52) U.S. Cl. 106/35

(57) ABSTRACT

A dental retrograde-filling material process, comprising the steps of: taking 3:1 mole ratio of a calcium oxide and a silicon dioxide mixes a 1˜5 w.t. % cobalt oxide at 1200˜1800 degree Celsius temperature to get a A-product including a tricalcium silicate, a dicalcium silicate and a containing cobalt composition; taking 3:1 mole ratio of a calcium oxide and an aluminum oxide at 1200˜1800 degree Celsius temperature reacts a B-product including a tricalcium aluminate; taking 4:1:1 mole ratio of a calcium oxide, an aluminum oxide and a ferric oxide at 1200˜1800 degree Celsius temperature reacts a C-product including a calcium alminoferrite; and mixing the A-product, B-product and C-product are the retrograde-filling material. The dental retrograde-filling material mixes of taking 8:1:1 mole ratio of said tricalcium silicate, dicalcium silicate and containing cobalt composition, tricalcium aluminate and calcium alminoferrite.

### BACKGOUND OF THE INVENTION

1. Field of the invention

The present invention relates to a partial-stabilized cement (PSC) dental retrograde-filling material. More specifically, the present invention discloses a PSC dental retrograde-filling material comprising a cobalt composition.

2. Description of prior art

According to Weiger reports about success rates of conventional root canal curing, the root canal cured of loss rates was 10˜30% by root canal profession dentist or trained dentist for root canal curing. The root canal perforation, being a complication, attributed to root canal curing and root canal repair. It is the second reason of loss rates for root canal curing happened about 3˜10%. The most of train classes in root canal curing is failure thus the loss of root canal curing or frequency of root canal perforation.

The root-end therapy, root end cutting therapy and retrograde-filling therapy were usual curing therapy for failure root canal curing therapy and teeth for unable using root canal curing therapy. The invigorator of root canal was removed by root end cutting therapy and retrograde recess repair. Meanwhile, the root canal and canal of root end surrounding system is insulated by retrograde-filling therapy to interrupt microorganism infecting the root end system by the canal. The effect factor guided the option of the retrograde-filling material.

The retrograde-filling material was used to the silvery powder, gutta-percher, CAVIT, reinforced ZOE cement, complex resin and glass innomer cement from 1915. The silvery powder has demerits of generating hydrargyrum iron, generating corrosive, detention swell, organization pigmentation and the leakage. And, the guttta-percher operation was so difficult and reinforced ZOE cement has demerits of releasing eugenol and high-solubility solvent. Furthermore, the demerits of the CAVIT reacted with interstitial fluid and soluble in interstitial fluid. After 1970, the IRM demerit is sensitive for water, and the super EBA contained mass eugenol and the demerits were to release eugenol, high-solubility and caused inflammation. Further, the complex resin was so sensitivity for water that the therapy needs better skill, the polymerization of complex resin created shrinkage that has the leakage demerit and toxicity demerit. And, the glass innomer cement was sensitivity for water and moisture and the material property is thick and hard to dense-filling, the operation was so difficulty.

The function of retrograde-filling material, having perfect interruption ability to completely interfere the path of infection of microorganism, interrupted the all paths between root canal system and external surface of root canal system and perfect biocompatibility that directly contacts to biopsy besides no toxicity and guiding revival of organization that includes bones, periodontal organization attachment and cementum. Further more, the requirements of retrograde-filling material must be no deformation of volume, no organization pigmentation, non-solubility, no reacting with interstitial fluid, non-sensitivity for water, elimination virus growing and opacity of radiation to be judged quality of retrograde-filling material.

### SUMMARY OF THE INVENTION

It is an object of the present invention to provide a dental retrograde-filling material containing cobalt and process which add the CoO to replace, solid solution method, the Si atom and Ca atom for speeding up the process.

It is another object of the present invention to provide a dental retrograde-filling material containing cobalt and process for getting necessary hardness in a short time.

It is yet object of the present invention to provide a dental retrograde-filling material containing cobalt and process that add the CoO to increase the hydration product.

It is yet object of the present invention to provide a dental retrograde-filling material containing cobalt and process for creating a slice porous structure product to contribute the spaces of the fluid humor paths and interior growing bones and to assist in periodontal ligament attachment and alveolar bone growth.

The present invention discloses the partial-stabilized cement (PSC) material, having great sealing property, including tricalcium silicate, dicalcium silicate, tricalcium aluminate and calcium aluminoferrite. In the setting process, with it raising the pH value gets a antibiotic effect in sealing area. It is most important that the PSC has high-biocompatibility to contribute the growth and attachment of periodontal ligament. It is much help to dental healing and function in the future but the long-time setting time is a demerit to lead clinical operation problem.

The present invention discloses adding CoO to conventional PSC in high temperature process. The transitional element replaces the Ca atom and Si atom of PSC for increasing the activation and imperfection concentration in order to material in metastable state to speed up the hydration of material and water for the short setting time and high hardness because the PSC reacts with water to set in high temperature process.

### BRIEF DESCRIPTION OF THE DRAWINGS

The above and further objects, features and advantages of the invention will become clear from the following more detailed description when read with reference to the accompanying drawings in which:

FIG. 1 is a flow chart of the present invention;

FIG. 2 is an illustration view showing the PSC structure of the present invention;

FIG. 3 is an illustration view showing the microhardness of PSC of the present invention;

FIG. 4 is an illustration view showing the hydration of PSC of the present invention;

FIG. 5 is a photo view showing SEM of non-adding cobalt oxide of the present invention; and

FIG. 6 is a photo view showing SEM of adding cobalt oxide of the present invention.

### DETAILED DESCRIPTION OF PREFERRED EMBODIMENTS

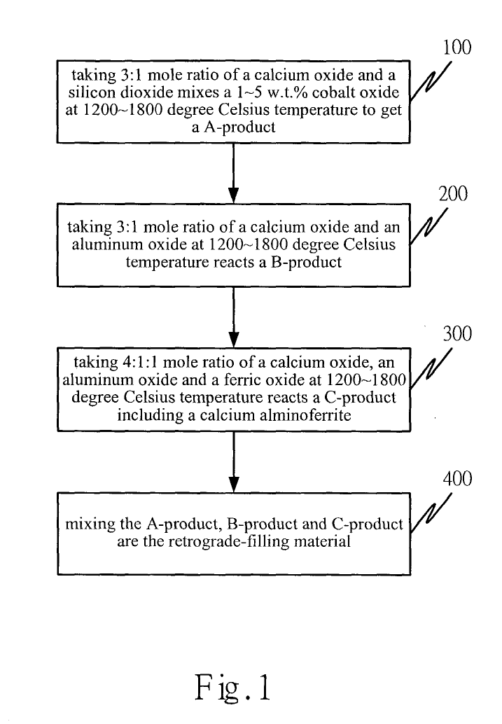

Referring to FIG. 1, the present invention discloses the dental retrograde-filling process, the steps comprises:

Step 100, taking 3:1 mole ratio of a calcium oxide and a silicon dioxide mixes a 1˜5 w.t. % cobalt oxide at 1200˜1800 degree Celsius temperature to get a A-product including a tricalcium silicate, a dicalcium silicate and containing a cobalt composition;

Step 200, taking 3:1 mole ratio of a calcium oxide and an aluminum oxide at 1200˜1800 degree Celsius temperature reacts a B-product including a tricalcium aluminate;

Step 300, taking 4:1:1 mole ratio of a calcium oxide, an aluminum oxide and a ferric oxide at 1200˜1800 degree Celsius temperature reacts a C-product including a calcium alminoferrite; and

Step 400, mixing the A-product, B-product and C-product are the retrograde-filling material.

Taking 8:1:1 mole ratio of a tricalcium silicate, dicalcium silicate and containing cobalt composition, tricalcium aluminate and calcium alminoferrite are the retrograde-filling material containing cobalt composition. The best heating temperature of A-product the is 1400 degree Celsius temperature at 2 to 4 hours, the best operation time is 2 hours, and further comprises a step: taking the A-product after heating is rapid cooling by a nitrogen solution. The best heating temperature of B-product is 1400 degree Celsius temperature at 2 to 4 hours, the best operation time is 2 hours, and further comprises a step: taking the B-product after heating is rapid cooling by a nitrogen solution. And, the best heating temperature of C-product is 1350 degree Celsius temperature at 2 to 4 hours, the best operation time is 2 hours, and further comprises a step: taking the C-product after heating is rapid cooling by a nitrogen solution.

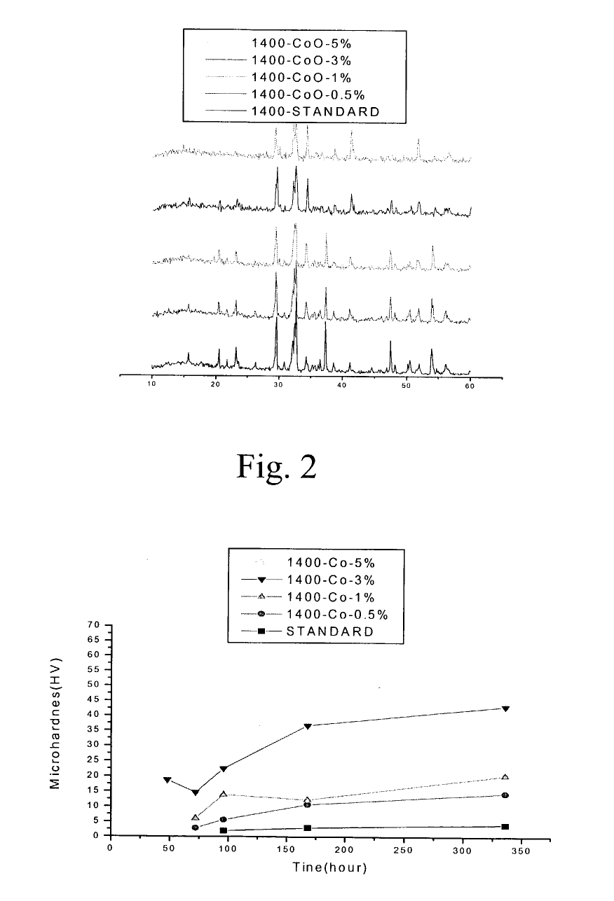

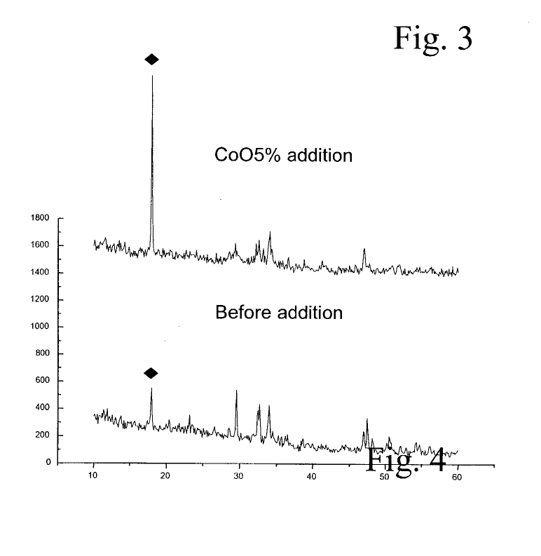

Referring to FIG. 2, the present invention discloses the calcium oxide decrease and the tricalcium silicate increase in the product because the cobalt atom has high-activation to be replaced the low-activation of Si atom or Ca atom for speeding up the process by solid solution. Furthermore, referring to FIG. 3, the micro-hardness of adding cobalt oxide Lab was 67HV after 14 days hydration and the micro-hardness of non-adding cobalt oxide Lab was only 5HV. So, the solid solution of cobalt atom increases the imperfection concentration in material and the PSC, in metastable state, highly reacts with water and the necessary hardness satisfies in a short time.

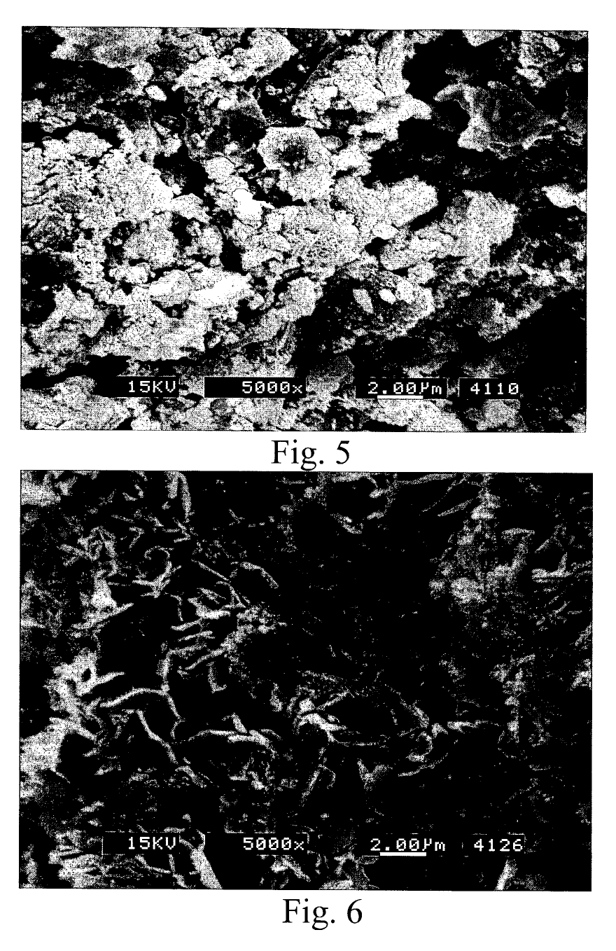

Referring to FIG. 4, the amount of portlandite of hydration product is much than the non-adding cobalt oxide Lab. The cobalt oxide gets the material in instability state and increases the hydration product. Referring to FIG. 5, the surface of non-adding cobalt oxide Lab does not show the hydration product. Referring to FIG. 6, the adding cobalt oxide Lab shows the slice porous structure product to contribute the spaces of the fluid humor paths and interior growing bones and to assist in periodontal ligament attachment and alveolar bone growth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A dental retrograde-filling material process, comprising the steps of:
taking 3:1 mole ratio of a calcium oxide and a silicon dioxide mixes a 1˜5 w.t. % cobalt oxide at 1200˜1800 degree Celsius temperature to get a A-product including a tricalcium silicate, a dicalcium silicate and containing a cobalt composition;
taking 3:1 mole ratio of a calcium oxide and an aluminum oxide at 1200˜1800 degree Celsius temperature reacts a B-product including a tricalcium aluminate;
taking 4:1:1 mole ratio of a calcium oxide, an aluminum oxide and a ferric oxide at 1200˜1800 degree Celsius temperature reacts a C-product including a calcium alminoferrite; and
mixing said A-product, B-product and C-product being said retrograde-filling material.

2. The process of claim 1, wherein the best heating temperature of A-product is 1400 degree Celsius temperature.

3. The process of claim 1, wherein the heating time of A-product is 2 to 4 hours.

4. The process of claim 3, wherein the best heating time of A-product is 3 hours.

5. The process of claim 1, wherein further comprises a step: said A-product after heating being rapid cooling by a nitrogen solution.

6. The process of claim 1, wherein the best heating temperature of B-product is 1400 degree Celsius temperature.

7. The process of claim 1, wherein the heating time of B-product is 2 to 4 hours.

8. The process of claim 7, wherein the best heating time of B-product is 2 hours.

9. The process of claim 1, wherein further comprises a step: said B-product after heating being rapid cooling by a nitrogen solution.

10. The process of claim 1, wherein the best heating temperature of C-product is 1350 degree Celsius temperature.

11. The process of claim 1, wherein the heating time of C-product is 2 to 4 hours.

12. The process of claim 11, wherein the best heating time of C-product is 2 hours.

13. The process of claim 1, wherein further comprises a step: said C-product after heating being rapid cooling by a nitrogen solution.

14. A dental retrograde-filling material comprising:
a tricalcium silicate, dicalcium silicate and containing cobalt composition;
a tricalcium aluminate;
a calcium alminoferrite;
wherein said dental retrograde-filling material mixes of taking 8:1:1 mole ratio of said tricalcium silicate, dicalcium silicate and containing cobalt composition, tricalcium aluminate and calcium alminoferrite.
